(19) United States
(12) Patent Application Publication
(10) Pub. No.: US 2022/0058557 A1
(43) Pub. Date: Feb. 24, 2022

(54) ONE KIND OF MAN-MADE SKI RESORT OPERATION AND MANAGEMENT SYSTEM AND MANAGEMENT METHOD

(71) Applicant: CLAYDON GROUP LIMITED, Hong Kong (CN)

(72) Inventor: Pierre-Nicolas-Jean BOJARSKI, Saint Nizier Du Moucherotte (FR)

(73) Assignee: CLAYDON GROUP LIMITED, Hong Kong (CN)

(21) Appl. No.: 17/413,531

(22) PCT Filed: Dec. 3, 2019
(86) PCT No.: PCT/CN2019/122634

§ 371 Date: Jun. 11, 2021

(30) Foreign Application Priority Data
Dec. 12, 2018 (CN) 201811515722.5

(51) Int. Cl. G06Q 10/06; G06F 16/29; G06K 9/00

(52) U.S. Cl. CPC G06Q 10/06315; G06Q 10/06316; G06K 9/00671; G06K 9/00335; G06F 16/29

(57) ABSTRACT

The present disclosure relates to a man-made ski resort operation and management system, including: ski slope environmental data processing modules, to receive ski slope environmental parameters, judge if the environmental data of each ski slope in the man-made ski resort map are within the preset critical value, to define the zones of ski slope in which the ski slope environmental data are not within the preset critical values, and sending the defined ski slopes network digital map to ski slope dispatch control centers; the ski slope dispatch control center is used to real-timely receive the defined man-made ski slopes network digital map, as well as the transportation needs, and create a stop-ski order for the non-skiable zones according to the defined map and real-timely send to each vehicle dispatch control center.

### TECHNICAL FIELD

This disclosure relates to the field of vehicle driving behavior analysis, especially involving one kind of man-made ski resort operation and management system and management method.

### BACKGROUND OF THE INVENTION

In the following aerial lift means: chairlift, gondola lift, cable car . . .

In ski resort, the skiers always go up from bottom to the top of ski slopes by taking some transportation tools and then ski down. At present, limited by fixed pick-up location of transportation tools, such as: aerial lift, surface lift and magic carpet, the skiers have to go to the fixed pick-up location themselves and ride up to the top of ski slopes. Meanwhile, limitation of pick-up location of transportation tools also results that ski slopes in a ski resort are operated with fixed pick-up and fixed drop-off locations, i.e. the operation is carrying out only following pick-up and drop-off locations of transportation tools, this severely affects the ski resort design and operation. For example, when the weather (wind) on partial limited area of the ski resort is not good and results in the transportation tool (aerial lift) to be stopped, then the whole ski resort may have to be closed. Also, when small part of ski slope is not suitable for ski or the snow on the slopes do not meet the requirements for skiing, the operator makes decision to close/open large zone of the slope network to the skier. If because of the bad weather in partial zone of the slope and the transportation tool stops to operate, not only the zone of slope with bad weather being closed, but also all the linked ski slopes.

In addition, due to the limitations of pick-up location of transportation tools, the hotels near the pick-up location of the ski slope charge high price and those far from the pick-up locations of the ski slope charge low price.

At present, as shown in FIG. 1, ski slopes 2 are serviced mainly by lifts 3 and these lifts loading and unloading locations are fixed in position, ski slopes 2 have fix bottom of ski lift 31 and fix top of ski lift 32. All the lift system need concrete foundations for the line towers, so any relocation during the winter is nearly impossible and lifts are not ecologically friendly. Only very short lift (rope tow) can be moved within few days.

The loading point, also known as pick-up location, means the area where skiers or goods or passengers can load in the transportation system. The unloading point, also known as drop-off location, means the area where skiers or goods or passengers on the transportation system can get off. Pick-up points and drop-off points can also with meet various other needs of a ski resort, as for: ski school lesson, the restaurant supply, carrying the snow or the snow making machine.

The loading/unloading points of lifts are fixed in locations, so the ski slopes only can be operated with fixed starting and fixed ending locations. If any location along a slope is not skiable, the whole slope have to be closed. If the bottom or the top of a lift is not accessible by ski, the whole lift needs to be closed and all the slopes linked to this lift needs to be closed as well. The lack of skiable condition in one location disturbs the whole of the ski resort, even if the rest of the resort is skiable. As shown in FIG. 2, if the bottom of the ski resort does not have enough snow for skiing, thus skiers cannot come back to the ski resort by ski, then, the entire ski resort needs to close, i.e. the lack of snow in zone 4 result that the area 5 is skiable but unusable. This could be a case if global warming reduces the snow quantity at bottom of the ski slopes.

Because of national safety rules aerial lifts have limitation to operate at night. Today, night operation of altitude restaurant with no road access is limited to only good skiers that can ski down at night. Today altitude hotel without road access, cannot be operated smoothly because of the access lift closed at night and client have difficulty in reaching or leaving the hotel surrounded by snow.

In a large ski slope network, the snow making machine systems need: water pipe, electricity power, compressed air pipeline, communication cable . . . along the ski slopes. This network is most of the time underground, fixed in position and custom made to water pressure and water hourly capacity. So snow making machines' water and electricity supply are only fixed in location along the ski slope networks.

In addition, the original design of aerial lift should include, from the beginning, the specification of the future hourly capacity even if this high hourly capacity is not needed during some period of time. This make the original investment more expensive and in addition it has to bet on the possible skier market increase, so during the early stage operation of a ski resort, the aerial lift is over invested and has low occupancy rate. Then the ski resort may not be able to pay back the investment during the first few years of operation.

Aerial lifts are fixed in position and are custom design for a given mountain, and aerial lifts are costly to move to another location. Because of this, there is not any official secondhand market for aerial lift mortgage value, and it cannot be rent or lease leasing.

The aerial lift has a long delivery and installation time, lasting from half a year to 1 year.

Each aerial lift needs safety control inspection by government competent department inside the ski resort, it's time consuming and affects the ski resort operation.

Hourly capacity of aerial lift is limited by loading/unloading arrangement, even most of the loading/unloading is done while the vehicle is moving at low speed, and, there are difficulties and safety concerns for skiers.

The aerial lifts make the ski resort operation very sensitive to stoppage (as wind) or breakdown of the lifts. Sometimes if an aerial lift stops for operation, then the ski slopes served by the lift have to be closed.

Aerial lifts are fixed in position and the top station should be located in a place servicing as many as possible ski slopes starting from this location which limit the possibility of design of the ski slope network and reduce the profitability.

In a ski slope network, it is common that most the skiers change the area to ski to another area at the same time, for instance: following the sun and avoiding the cold shadow side, or changing to a location where in the afternoon the snow is better quality . . . Today each area needs to have a full-size lift (high hourly capacity) even if the lift has low occupancy rate at some time during the day. This is creating over investment and low occupancy rate of some lift and ski slopes.

When an aerial lift has a stoppage or breakdown the full lift stops. If an evacuation is necessary, it can take several hours to evacuate all passengers, and in skiing temperatures below −10° C. it can be very dangerous for the passengers.

After a breakdown, the lift needs to be fixed during the night before the next morning opening, making pressure on the employees to work under very hard environment and even becoming dangerous especially during windy night if temperature is below −20° C.

Most of lift technology are obliged to have the same vehicle to transport passenger. Only combi lift can accommodate chair/cabin at the same time. This does not allow the sales of the 1^{st} class and economy class lift tickets, but can only be possible according lifts usage.

Snow Making

Conventional snow making machines are fixed in location while making snow, and they make snow packs, then grooming machine is needed to spread snow evenly on ski slopes. While making snow at fixed locations, snow near the machine is good in quality, but poor in far area. Skiers are not satisfied with this snow change in quality along the ski slope, which further increase the danger on ski slopes, sometimes, the snow quality change from icy crust to soft snow, even just from 60 m to 80 m in length, it is hard for skiers to accept.

### SUMMARY OF THE INVENTION

In view of the above-mentioned problems, putting forward this disclosure, so as to provide a man-made ski resort operation and management method to solve, or at least partly solve, all the above-mentioned problems.

This disclosure is to have a better ski slope operation and management with higher occupancy rate and better safety and create a new mountain high capacity transit system allowing: mobile pick-up and drop-off points for skiers, higher transport hourly capacity, longer transport distance, better snow quality. This disclosure create ski resort new business concept, new ski slope network design, different urbanism concept, faster construction, change the operating concept, and better operation efficiency at a cheaper investment cost.

This disclosure, in one aspect, provides one kind of man-made ski resort operation and management system, including:

Ski slope environmental data processing modules are used to receive ski slope environmental data, judge if the environmental data of each ski slope in the man-made ski resort map are within the preset critical values, to mark the zones of ski slope in which the ski slope environmental data are not within the preset critical values, and send the marked ski slopes network digital map to ski slope dispatch control center;

The ski slope dispatch control centers are used to real-timely receive the marked man-made ski slopes network digital map and create a stop-ski order for the not-skiable zones and real-timely send to each vehicle terminal within the dispatchable vehicle system.

Further, the ski slope environmental data includes: the thickness of snow on the slope, the hardness of snow on the slope, the density of snow on the slope, the weather conditions of ski resort area, if there are obstacles on the slope, the image analysis, the user information and request.

Further, ski slope environmental data processing module communicate with and is electrically connected to the ski slope dispatch control center.

Further, the above-mentioned man-made ski resort operation and management system, also including: the ski slope environmental parameter database which is used to receive and store the ski slope environmental parameters, and send the ski slope environmental parameters to the ski slope environmental data processing module.

Further, the ski slope environmental parameter database communicates with the ski slope environmental data processing module.

Further, the man-made ski resort digital maps are stored both in the ski slope environmental data processing module and the ski slope dispatch control center, this man-made ski resort digital map includes all ski slopes of the ski resort area, the accommodations, restaurants, car park, ski school and restaurant locations in ski resort area, and the vehicles real-time locations.

Further, the ski slope environmental data processing module is also used to: receive the data of passenger numbers predetermined by each ski resort accommodation, car park, restaurant, ski school and location calculate the vehicles needed at each accommodation, car park, restaurant, ski school and location pickup and drop-off locations according to the predetermined passenger numbers, and send the needed vehicle numbers at each accommodation, car park, restaurant, ski school and locations to the ski slope dispatch control center.

Further, the above-mentioned man-made ski resort operation and management system, also including: the vehicle dispatchable control center, including many vehicles, each vehicle is used to receive the executive order sent by the ski slope dispatch control center, and the vehicle moves according to the executive order.

Further, each vehicle in the dispatchable vehicle system communicates with and is connected to the ski slope dispatch control centers.

Further, each vehicle in the dispatchable vehicle system includes vehicle engine and vehicle cabin, and the vehicle cabin is determined according to the object to be transported.

Further, each vehicle in the dispatchable vehicle system is Alvis Bv206S caterpillar armored or other full terrain vehicle.

Further, the ski slope dispatch control center is also used to receive the request of dispatching vehicles given by mobile terminals and resolve the vehicle dispatch request into vehicle using information as using location and objects waiting for transportation, give the transportation order to vehicles which are the closest and suitable for the object to be transported according to the vehicle using information of the location and the object to be transported.

Further, the ski slope environmental data received by the ski slope environmental parameter database are sent through manual input or sensors or external database.

Further, the ski slope dispatch control center is also used to receive the ski slope images, captured by cameras or sensors permanently monitoring the ski slopes, to analyze and detect the traffic flow on a ski slope, when the traffic on the slope is over the preset critical value, edit and send to the ski slope dispatch control center instructions of stopping or reduce or reroute to another slope and to divert ski slope users away from the over-loaded ski slope.

Further, the ski slope dispatch control center is also used to receive the ski slope images, captured by cameras or sensors permanently monitoring the ski slopes, to analyze and detect the obstacles and their dangerous level on ski slopes, when the dangerous level on the ski slope is amounting up to the preset critical value, edit and send to the ski slope dispatch control center instructions of stopping or reduce or reroute to another ski slope, to guide the ski slope users out of the ski slope with obstacles.

Further, the ski slope dispatch control center is also used to receive the ski slope images, captured by cameras or sensors permanently monitoring the ski slopes, to analyze and detect accidents on a ski slope, when there is an accident on the slope, edit and send to the ski slope dispatch control center instructions and to guide skiers out of the ski slope with accident.

Further, the ski slope dispatch control center is also used to receive the ski slope images, captured by cameras or sensors permanently monitoring the ski slopes, to analyze and detect the traffic on a ski slope, the Ski slope dispatch control center informs the ski slope users through mobile terminals and screens along ski slopes and in the ski resort and in Vehicles.

Further, the ski slope dispatch control center is also using AI (artificial intelligence) to predict the ski slope traffic flow according to the past experience and the today environment and conditions.

This disclosure, in another aspect, provides one kind of management method of realizing above-mentioned man-made ski resort operation and management system, including:

Making use of the ski slope environmental data processing module to receive ski slope environmental parameters, judging if the environmental parameters of each ski slope in the man-made ski resort map are within the preset critical values, to mark the zones of ski slope in which the ski slope environmental parameters are not within the preset critical values, and sending the marked ski slopes network digital map to ski slope dispatch control center; the ski slope dispatch control center is used to real-timely receive the marked man-made ski slopes network map and create a stop-ski order for the not-skiable zones according to the marked digital map and real-timely send to each vehicle terminal.

Further, the above-mentioned man-made ski resort operation and management method also includes: taking use of the ski slope environmental parameter database to receive and store the ski slope environmental parameters, and send the ski slope environmental parameters to the ski slope environmental data processing module.

Further, the man-made ski resort digital maps are stored both in the ski slope environmental data processing module and the ski slope dispatch control center, this man-made ski resort digital map includes all ski slopes of the ski resort area, the accommodations, car parks, ski schools and restaurants locations in ski resort area, and the vehicles real-time locations.

Further, the above-mentioned man-made ski resort operation and management method also includes: making use of environmental data processing module to receive the data of reservation made in the ski resort's each accommodation, car park, restaurants and ski school according to the reservation number to calculate vehicles needed at each accommodation, car park, restaurant and ski school locations, and send the vehicle numbers needed at each accommodation, car park and restaurant locations to the ski slope dispatch control center.

Further, the above-mentioned man-made ski resort operation and management method also includes: making use of each vehicle in the dispatchable vehicle system to receive executive orders sent by the ski slope dispatch control center, and vehicles move according to the executive orders.

Further, the above-mentioned man-made ski resort operation and management method also includes: ski slopes environmental data processing module, to receive transportation needs sent through users' mobile terminals, to elaborate the transportation needs into information of transport location and objects waiting for transport, and according to the information of the location and objects to issue transport order to vehicles closest to the location and suitable for the objects waiting for transport.

Further, the above-mentioned man-made ski resort operation and management method also includes: making use of ski slope images received regularly by the ski slope dispatch control center, to analyze and detect the skier quantity and traffic on a ski slope, when the traffic on the slope is over the preset critical value, edit and send to the ski slope dispatch control center instructions to stop or reduce or reroute to another slope and so as to divert ski slope users away from the over-loaded ski slopes.

Further, the above-mentioned man-made ski resort operation and management method also includes: making use of ski slope images received regularly by the ski slope dispatch control center, to analyze and detect the obstacles and their dangerous level on a ski slope, when the dangerous level exceeds the preset critical values, edit and send to the ski slope dispatch control center instructions to revise the route, in order to guide the ski slope users out of the ski slope with obstacles.

Further, the above-mentioned man-made ski resort operation and management method also includes: making use of ski slope images received continuously by the ski slope dispatch control center, to analyze and detect accidents on a ski slope, when there is an accident on the slope, edit and send to the ski slope dispatch control center the instructions of the accident and to guide the ski slope users out of the ski slope with accident.

Further, the above-mentioned man-made ski resort operation and management method also includes: making use of ski slope monitoring images received by the ski slope dispatch control center, to analyze and detect the traffic on a ski slope, the Ski slope dispatch control center sends the information to users' mobile terminals and has them displayed on screens installed along ski slopes and in the resort or in the Vehicles.

Further, the above-mentioned man-made ski resort operation and management method also includes: making use of the ski slope dispatch control center and its AI (artificial intelligence) to predict the ski slope traffic follow according to the past experience and the today conditions.

Further, the Man-made ski resort operation and management system in this disclosure may have multiple: Ski slope environment data processing modules, vehicle dispatch control center, ski slope environmental parameters, man-made ski resort digital map and ski slope dispatch control centers, may be spread in various different locations including inside vehicles.

Compared with the existing technology, the man-made ski resort operation and management system and method provided by this disclosure has following improvements:

1. The ski slope environmental data processing module in this disclosure works out the not -skiable zones of ski slope according to ski slope environmental parameters, give out new loading/unloading locations and send them to ski slope dispatch control center, the ski slope dispatch control center real-timely sends the new loading/unloading locations to each vehicle within the dispatchable vehicle system, ensures the skiable slopes continue to operate in the way that the vehicles transport the waiting passengers from pick-up location to drop-off location avoiding for skier the not-skiable zones.
2. The ski slope environmental data processing module in this disclosure calculate the vehicles needed at each accommodation, car park, restaurant and ski school locations according to booking made at each accommodation, car park, restaurant and ski school and send the needed vehicle numbers at each accommodation, car park, restaurant and ski school locations to the ski slope dispatch control center, so as to reasonably arrange the vehicles in the dispatchable vehicle system and realize the high usage of dispatchable vehicle.
3. The ski slope environmental data processing module in this disclosure is, with the assistance of images analysis, sensors and GPS on skier's mobile terminals, to calculate his/her behavior and location and give skiers and concerned services advises to improve the safety and management of the ski resort.

When vehicles equipped with snow making machine and water tanks are manufacturing snow in low speed movement, snow can be evenly sprayed on a ski slope. Before the ski season or during nights when vehicles stop to transport skiers, vehicles can be converted into moving snow making machine. To keep high quality snow for the skier, the best method is to manufacture a few mm of new snow every day on all ski slopes. The vehicles can add every night a few mm of snow on all ski slopes without need of grooming. The safety on ski slopes and the width of ski slopes are increased because there is no more snow making machine along ski slopes that skiers may crash onto them.

As vehicles are operated independently from each other it is possible to operate different type of vehicle at the same time as for instance: economy class with 25 seat, and 1^{st} class offering better comfort with only 16 seats, or special vehicle for special event.

The above specification is only the technical summarization of this disclosure, in order to understand more clearly the technical method of this disclosure, and implement can be made according to instruction manual and in order to make the above and other purposes, characteristics and advantages of this disclosure clearer and easy to be understood, below shows the specific implementation of this disclosure.

### BRIEF DESCRIPTION OF THE DRAWINGS

By reading the detailed description of optimized implementation in the following contexts, all kind of other advantages and benefits become clearer to common technicians in this field. The attached figures are only used to show the purpose of optimized implementation and don't consider they are the limit to this disclosure. In the figures, the same reference symbols are used to show the same components. In the figures:

FIG. 1 is a current ski resort sketch diagram;

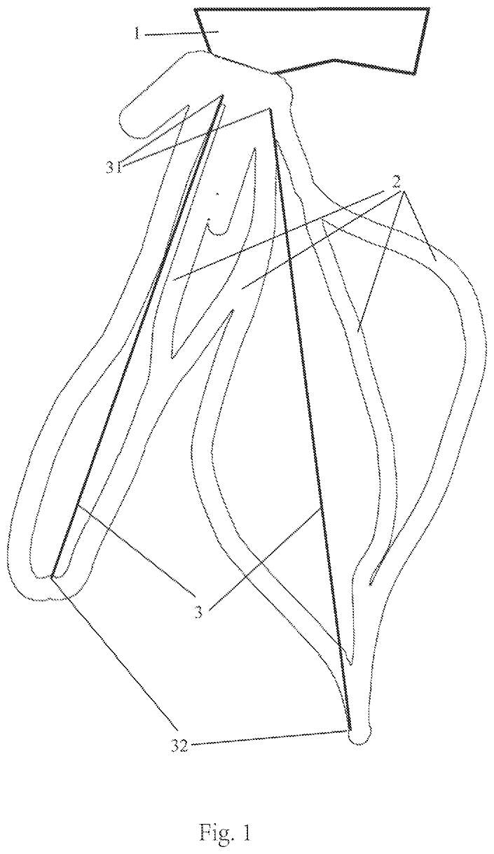

FIG. 2 is a sketch diagram of common operation problem in current ski resort;

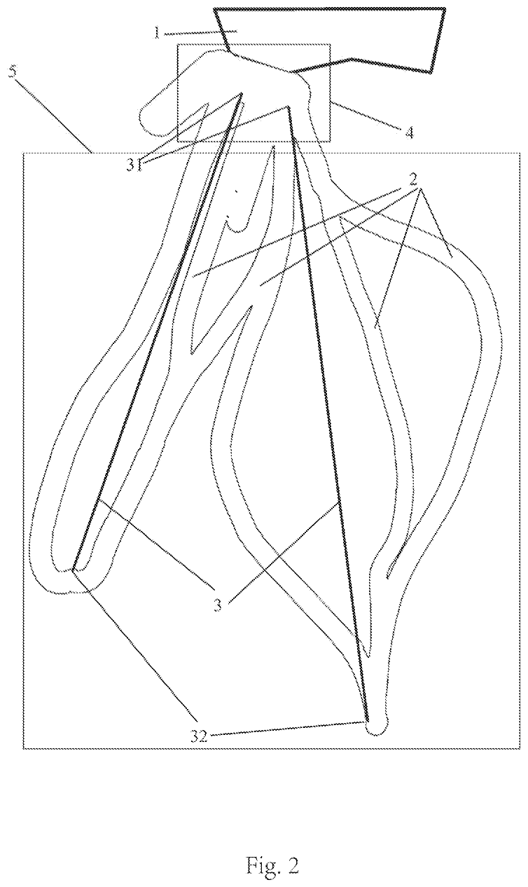

FIG. 3 is a block diagram of man-made ski resort operation and management system in this disclosure;

FIG. 4 is a flow chart of man-made ski resort operation and management method in this disclosure;

FIG. 5 is a ski resort operation sketch diagram in this disclosure;

FIG. 6 is a sketch diagram of the available transportation for skiers according to different case of not skiable zone in this disclosure;

FIG. 7 is a sketch diagram of the available transport connection of two ski slopes with separated skiable zones;

FIG. 8a is a sketch diagram of new pick-up and drop-off locations when a ski resort which has the bottom of the resort closed;

FIG. 8b is a sketch diagram of new pick-up and drop-off locations when a ski resort which has the top of the resort closed;

FIG. 9 is a sketch diagram of different not skiable zone in the ski slopes of this disclosure.

In the attached figures:

1—Village/Day-lodge, 2—the Ski slopes, 3—the Ski lift, 31—Fix bottom of ski lift, 32—Fix top of ski lift, 4—Missing snow zone, 5—Skiable but unusable area, 6—Not skiable zone, 7—Skiable zone, 8—New pick-up location, 9—Pick-up location, 10—New Drop-off location, A—Village, B—New pick-up location, C—New Drop-off location, D—New pick-up location, E—New Drop-off location, F—Mountain top, G—Village/Day-lodge, H—New pick-up location, I—New pick-up location, J—New Drop-off location, K—New Drop-off location, L—Mountain top, 11—Pick-up location, 12—Drop-off location,

### DETAILED DISCLOSURE OF THE INVENTION

Below reference will be made to the attached figures, to have a more detailed description of this publicized illustrative example for implement. Although the publicized illustrative example for implement has been showed in the attached figures, but it should be understood that this disclosure can be realized in various way and should not be limited by the illustrative example described here. On the contrary, to provide these illustrative example is to enable a more thorough understanding of the disclosure and to fully pass on the disclosure to the technicians in this field.

The technicians in this field are to understand that, unless otherwise defined, all terms (including technical terms and scientific terms) used here has the same meaning as the general understanding of the common technician in the field of the disclosure. It should also be understood that terms such as those defined in a general dictionary should be understood to have meaning consistent with that in the context of an existing technology, and should not be explained in an idealized or overly formal implication unless specifically defined.

This disclosure is aimed at how to operate a ski slope network with a partially open/close ski slope. With the system and method of this disclosure, it become possible to operate a ski slopes networks even with part of the ski slope network are not skiable or some portions of ski slope are closed. This means that the ski slopes need to have starting and ending locations variable in time or movable in location. The variation of starting or ending location of the ski slope may be due to various reasons as: snow quantity or quality, risks such as avalanche, wind, fog, skier safety, decision of the operator and etc.

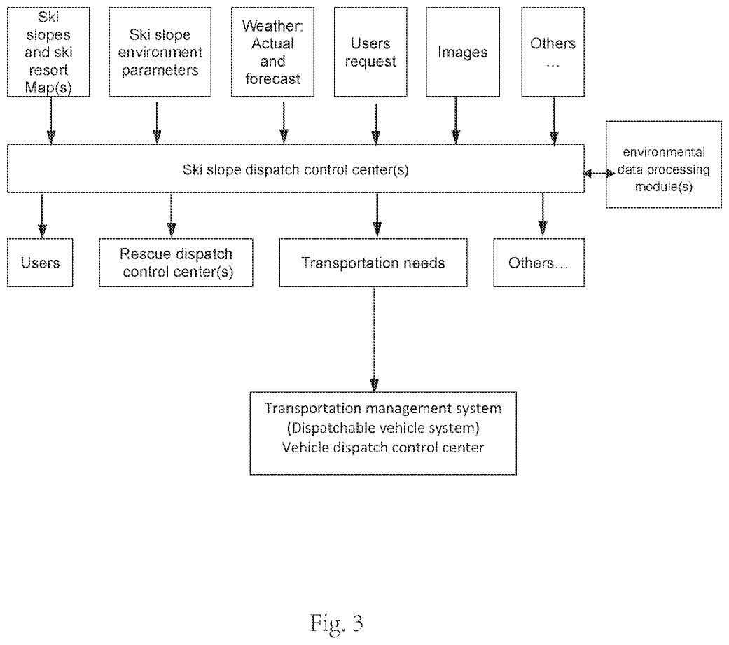

As shown in FIG. 3, the man-made ski resort operation and management system in this disclosure includes:

Ski slope environmental data processing module, to receive ski slope environmental parameters, judging if the environmental parameters of each ski slope in the man-made ski resort map is within the preset critical values, to mark the zones of ski slope in which the ski slope environmental parameters are not within the preset critical value, and sending the marked ski slopes network digital map to ski slope dispatch control center;

The ski slope dispatch control center is used to real-timely receive the marked man-made ski slopes network digital map and create a stop-ski order for the not-skiable zones and real-timely send to each vehicle terminal within the dispatchable vehicle system.

In this disclosure “man-made ski resort” means a snow play ground where the ski slope network have more than 2000 m of cumulated length of water pipe along ski slope to supply water to man-made snow making machines and the actual number of skiers on the ski slope network at the same time is over 500 skiers and the cumulated length of ski slopes is over 3000 m, and the cumulated lift up hourly capacity is over 1000 pph.

The ski slope dispatch control center is used to real-timely give information to ski slope users.

This disclosure ensures the skiable slopes continue to operate in the way that the vehicles transport the waiting skiers from pick-up location to drop-off location out of the not-skiable zones.

The ski slope environmental data processing module in this disclosure work out the not-skiable zones of ski slope according to ski slope environmental parameters, given the new loading/unloading locations and send them to ski slope dispatch control center, the ski slope dispatch control center sends in real-time the new loading/unloading locations to each vehicle within the dispatchable vehicle system, ensures the skiable slopes continue to operate in the way that the vehicles transport the waiting passengers from pick-up location to drop-off location except the not-skiable zones. The ski slope environmental data processing module is electrically connected to the ski slope dispatch control center.

The ski slope environmental parameters includes: the thickness of snow on the slope, the hardness of snow on the slope, the density of snow on the slope, the weather conditions of ski resort area, if there are obstacles on the slope. The criteria, which vary with the ski resort environment, for ski slope could be as follow: the thickness of snow on the slope must be more than 10 cm, hardness of snow on the slope is less than 600 Pa and density of snow on the slope is 0.3-0.6 g/cm3; the weather condition in ski slope area: wind speed less than 60 km/h, visibility farther than 200 m, the light intensity is more than 300 lux day time and 20 lux for night ski, temperature is higher than −20° C. and the humidity is less than 90%.

See FIG. 3, the above-mentioned man-made ski resort operation and management system also includes: the ski slope environmental parameter database which is used to receive and store the ski slope environmental parameters, and send the ski slope environmental parameters to the ski slope environmental data processing module, the ski slope environmental parameter database communicate with the ski slope environmental data processing module. The ski slope environmental parameters received by the ski slope environmental parameter database are sent through manual input or automatic sensors or external database.

The man-made ski resort digital maps are stored both in the ski slope environmental data processing module and the ski slope dispatch control center, this man-made ski resort digital map includes all ski slopes of the ski resort areas, the accommodations, car parks, ski schools and restaurants locations in ski resort areas, and the vehicles real-time locations.

The ski slope environmental data processing module is also used for: receiving reservation data from each accommodations, car parks, restaurants and ski schools, according to the reservation number at each accommodation, car park, restaurant and ski school location according to calculate vehicle demand in number and schedule at each location, and send the needed vehicle numbers at each location to the ski slope dispatch control center, so as to reasonably arrange the vehicles in the dispatchable vehicle system and realize the high usage of dispatchable vehicle system.

The above-mentioned man-made ski resort operation and management system also includes: the dispatchable vehicle system, including many vehicles, each vehicle is used to receive the executive order sent by the ski slope dispatch control center, and the vehicle moves according to the executive order. The various vehicles in the dispatchable vehicle system are all connected and communicated with the ski slope dispatch control center. Each vehicle in the dispatchable vehicle system includes vehicle engine and cabin, and according to object to be transported to determine the vehicle cabin type. For example, daytime needs to carry the skiers, the cabin is passenger cabin, when no need to carry the skiers during night, the cabin is changed to carry snow. Of course, the passenger cabin is not only used to carry skiers, for instance in summer, the cabin can be used to carry tourists. The vehicle in the dispatchable vehicle system is Alvis Bv206S caterpillar armored full terrain vehicle, but not limited to this.

Ski slope dispatch control center is also used to receive the vehicle need given by user's mobile terminals and resolve the transportation need into transportation location information and object information to be transported, give the transportation order to the vehicles which are closest to transportation location and suitable for the object to be transported according to transportation location information and object information to be transported.

The man-made ski resort operation and management system in this disclosure include vehicle usage needs, that is to transport skiers from bottom of skiable ski slope to the top of skiable ski slope, when a ski slope leading to accommodation is skiable, to transport skiers back to their accommodation, along the ski slope to pick up skiers who are grounded half way and send them back to their accommodation, e.g. tired skiers or skiers grounded on too difficult ski slopes or lightly injured skiers who have given up skiing.

Further, the ski slope dispatch control center is also used to continuously receive the ski slope images, to analyze and detect the quantity and traffic on a ski slope, when the traffic on the slope is over the preset number, edit and send to the ski slope dispatch control center the instructions of stopping or reduce or reroute to another slope, for the purpose to guide ski slope users out of the over-loaded ski slope. Skier quantity Images are captured by the cameras or sensors monitoring ski slopes.

Further, the ski slope dispatch control center is also used to continuously receive the ski slope images, to analyze and detect the obstacle and their dangerous level on a ski slope, when the dangerous level detected exceeds the preset critical values, edit and send to the ski slope dispatch control center instructions of stopping or reduce or reroute to another ski slope, in order to guide the ski slope users away from the slope with obstacles. Obstacle images are captured by the cameras or sensors monitoring ski slopes.

Further, the ski slope dispatch control center is also used to continuously receive the ski slope images, to analyze and detect accidents on a ski slope, when there is an accident on the slope, edit and send to the ski slope dispatch control center instructions of shunting skiers from the ski slope with accident. Accident include avalanche.

Further, the ski slope dispatch control center is also used to receive real-time ski slope images, to do real-time analysis and detection of the quantity and traffic on a ski slope, send the information to mobile terminals of users and through screens installed along ski slopes and in the ski resort village have them displayed.

Further, the ski slope dispatch control center is also using AI to predict the ski slope traffic flow according to the past experience and the today conditions. AI means Artificial Intelligence.

The man-made ski resort operation and management system in this disclosure include: the skier information processing module, it is used to receive skier's action information, identify if a skier is in danger, for the purpose to generate execution orders and send orders out. Action information include:
i. When skiers fall down and no more moving information comes back, skiers are still on a ski slope after closing time, a skier is skiing on a ski slope which is too difficult to ski for him regarding his ski level ability.
ii. When the skier information processing module received information of a skier's fall-down and no further moving information comes, it will edit and send out rescue orders to ski slope dispatch control center for vehicle dispatch.
iii. When the skier information processing module received the information that a skier is still on a ski slope after closing time, it will edit and send out rescue information to ski slope dispatch control center for dispatching vehicles.
iv. When the skier information processing module received the information that a skier is skiing on a ski slope which is too difficult to ski for him regarding his ski level ability, it will edit and send out a warning to the skier's mobile terminal.

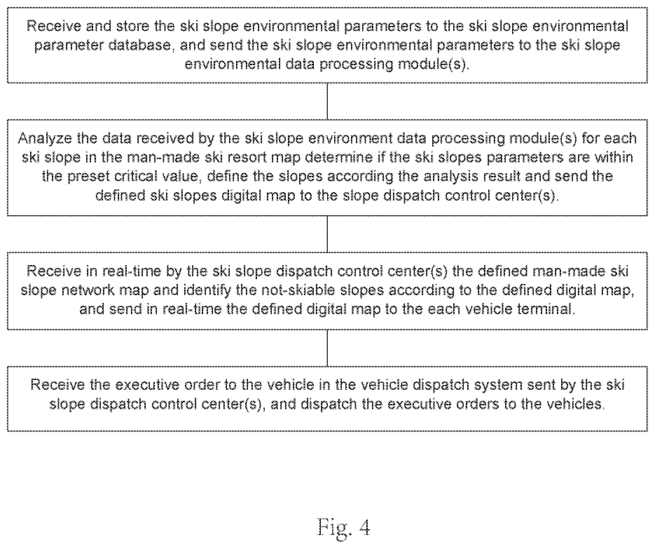

As shown in FIG. 4, this disclosure provides a method to realize the above-mentioned man-made ski resort operation and management system, including following steps:

Making use of the ski slope environmental data processing module to receive ski slope environmental parameters, judge if the environmental parameters of each ski slope in the man-made ski resort map are within the preset critical values, define the zones of ski slope in which the ski slope environmental parameters are not within the preset critical values, and send the defined ski slopes network digital map to ski slope dispatch control center;

The ski slope dispatch control center is used to real-timely receive the defined man-made ski slopes network map and according to the defined digital map create a stop-ski order for the not-skiable zones and real-timely send it to each vehicle terminal.

The ski slope environmental data processing module in this disclosure works out the non-skiable zones of ski slope according to ski slope environmental parameters, set the new loading/unloading locations and send them to ski slope dispatch control center. The ski slope dispatch control center real-timely sends the new loading/unloading locations to each vehicle within the dispatchable vehicle system, ensures the skiable slopes can be operated continuously in the way that the vehicles transport the waiting passengers from pick-up location to drop-off location.

The above-mentioned man-made ski resort operation and management method also includes: taking use of the ski slope environmental parameters database to receive and store the ski slope environmental parameters, and send the ski slope environmental parameters to the ski slope environmental data processing module.

The man-made ski resort digital maps are stored both in the ski slope environmental data processing module and the ski slope dispatch control center, this man-made ski resort digital maps include all ski slopes of the ski resort areas, the accommodations, car parks and restaurants and facilities locations in ski resort areas, and the vehicles real-time locations.

The above-mentioned man-made ski resort operation and management method also includes: making use of environmental data processing module to receive reservation data at various accommodations, car parks and restaurants, according to the reservation data to calculate vehicle demand in number at various accommodations, car parks and restaurants exits and give the vehicle demand data at each accommodation, car park and restaurant to the ski slope dispatch control center, so as to reasonably arrange the vehicles in the dispatchable vehicle system and realize the high usage of dispatchable vehicle.

The above-mentioned man-made ski resort operation and management method also includes: making use of each vehicle in the dispatchable vehicle system to receive the executive order sent by the vehicle dispatch control center, ski slope dispatch control center, and vehicles start off according to the executive order.

The above-mentioned man-made ski resort operation and management method also includes: making use of the ski slope dispatch control center to receive the transportation needs from user's mobile terminals and resolve the transportation needs into information of transportation location and passengers or goods to be transported, give the transportation order to vehicles which are closest and suitable for the object to be transported according to the information of transportation location and object to be transported.

Further, the above-mentioned man-made ski resort operation and management method includes: using of the ski slope dispatch control center to regularly receive the ski slope images, to do real-time analyses and detection of the skiers in quantity and traffic flow on a ski slope, when the traffic on the slope is over the preset values, edit and send to the ski slope dispatch control center instructions of stopping or reduce or reroute to another slope, for the purpose to shunt ski slope users off the over-loaded ski slope.

Further, the above-mentioned man-made ski resort operation and management method also includes: using of the ski slope dispatch control center to receive the ski slope images, to do real-time analyses and detections of the obstacle and the dangerous level on a ski slope, when the dangerous level exceeds the preset critical values, it will edit and send to the ski slope dispatch control center instructions of stopping or reduce or reroute to another ski slope, for the purpose to diverge the ski slope users out of the ski slope with obstacles.

Further, the above-mentioned man-made ski resort operation and management method includes: using of the ski slope dispatch control center to regularly receive the ski slope images, to do real-time analyses and detections of accidents on a ski slope, when there is an accident on the slope, it will edit and send to the ski slope dispatch control center instructions of shunting skiers off the ski slope with the accident.

Further, the above-mentioned man-made ski resort operation and management method also includes: using of the ski slope dispatch control center to real-timely receive the ski slope images, to real-timely analyze and detect the skier quantity and traffic on a ski slope, send information to users' mobile terminals and have it displayed on screens installed along ski slopes and in ski resort village.

Further, the above-mentioned man-made ski resort operation and management method also includes: using of the ski slope dispatch control center and its AI (Artificial Intelligence) technology to predict the ski slope traffic flow according to the past experience and the today conditions.

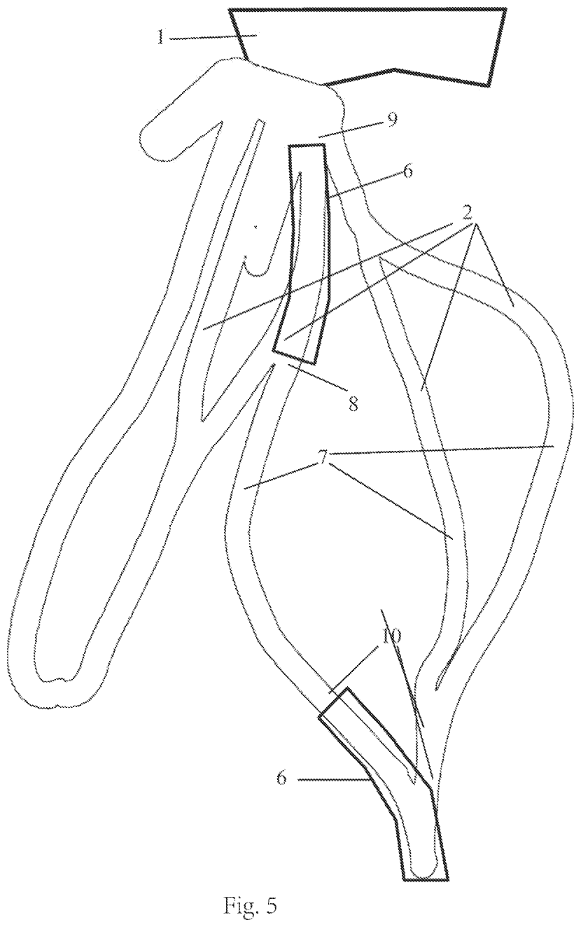

FIG. 5 is a ski resort operation sketch diagram of this disclosure, as shown in FIG. 5, ski resort includes village/day-lodge 1, Ski slopes 2, non-skiable zone 6, skiable zone 7, new pick-up location 8, pick-up location 9, new drop-off location 10, combined with the dispatchable vehicle system, the ski resort can operate continuously on skiable zone 7. So, the man-made ski resort operation and management system and management method in this disclosure allow variable length ski slope with the top and the bottom of the ski slope is not skiable. The middle section of the slope remains open with new pick-up 8 and drop-off locations 10 to allow skiing in this skiable zone 7. The village keeps its pick-up and drop-off location to allow skiers to come and go from the village to all skiable zones.

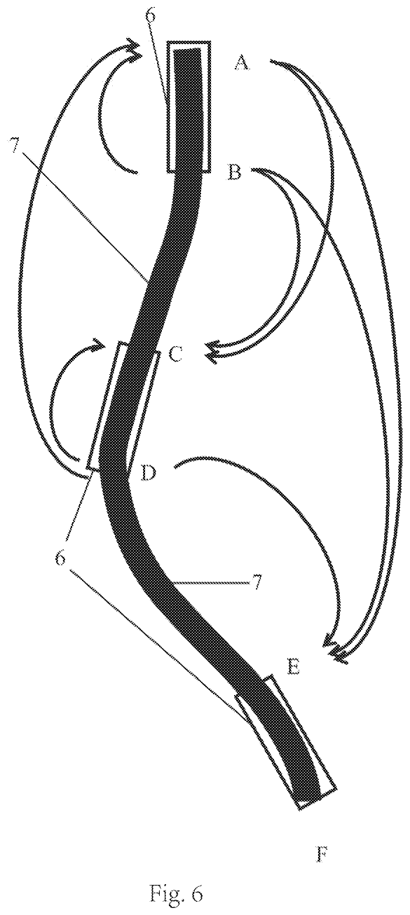

FIG. 6 is a sketch diagram of the available transportation for skiers according to different case of non-skiable zone, of this disclosure. When on a ski slope exists: the non-skiable zone 6 and the skiable zone 7, the skier can be transported by the dispatchable vehicle system from bottom village A to new drop-off locations C and E, from new pick-up location B to new drop-off location C,E and village A, from new pick-up location D to new drop-off location C,E and village A, from mountain top F to new drop-off location C,E and village A and etc.

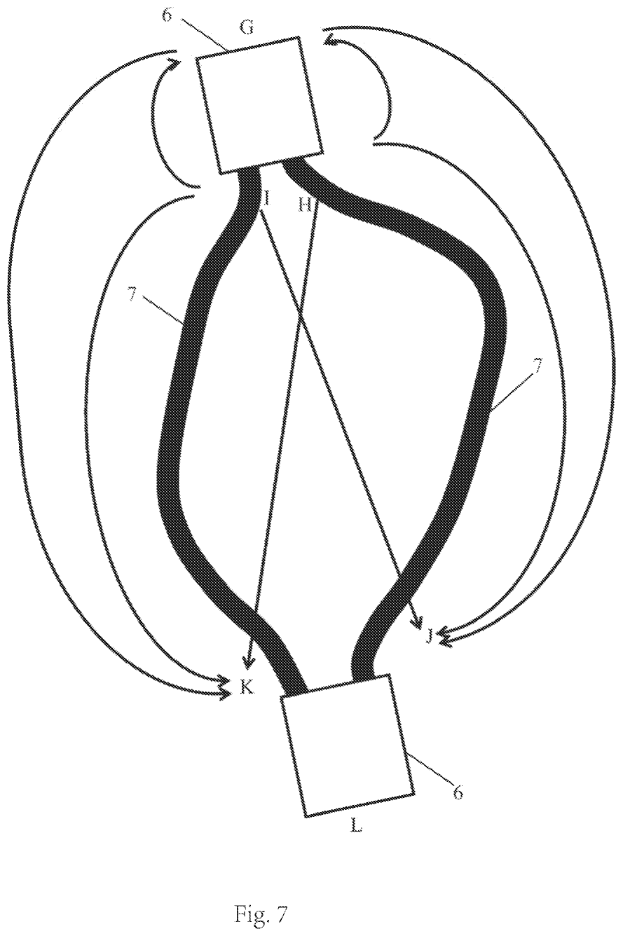

FIG. 7 is a sketch diagram of the available vehicle of this disclosure transport between two ski slopes with separated skiable zones. As show in FIG. 7, the available transport connection of two ski slopes with separated skiable zones. For example, Skiers is transported from new pick-up location H to new drop-off location K, from new pick-up location I to new drop-off location J, also can be from new pick-up location H, mountain top L and village/day-lodge G to new drop-off location K. and etc.

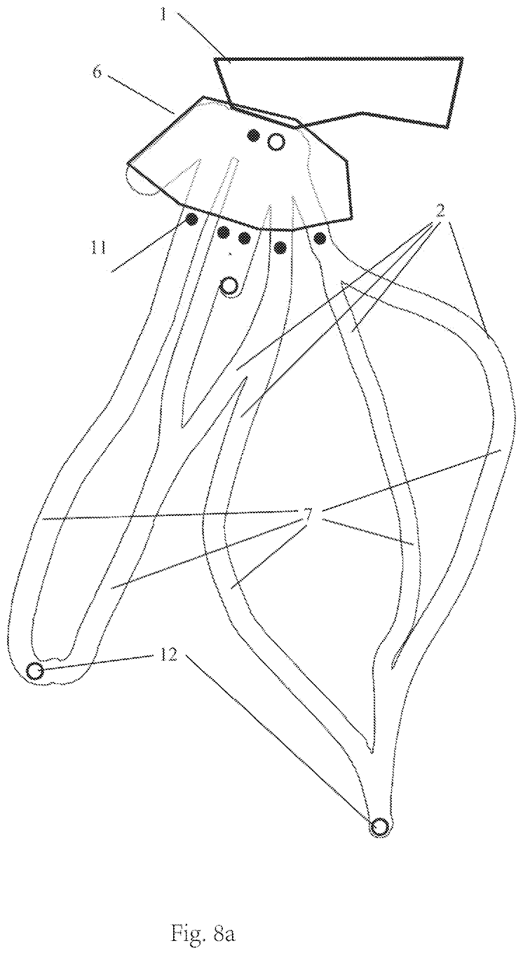

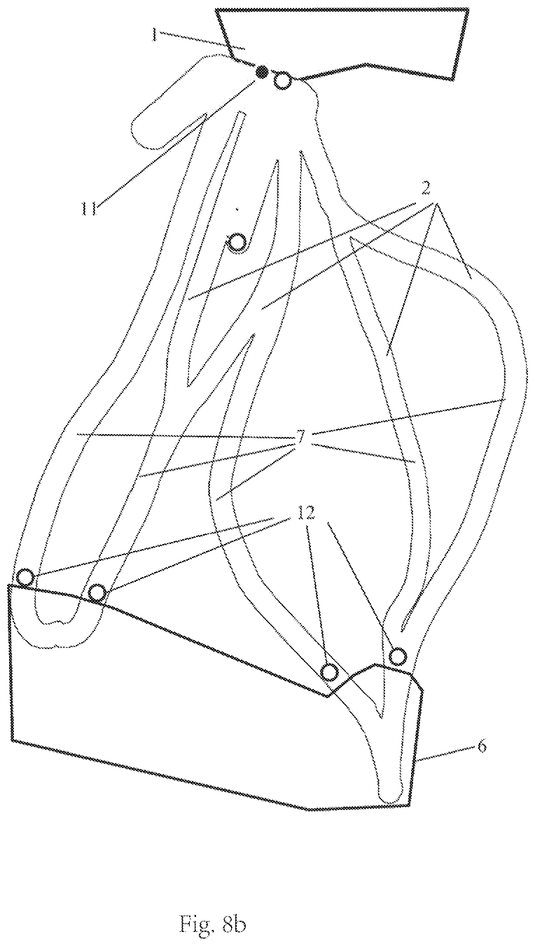

FIG. 8a is a sketch diagram of the new pick-up and drop-off locations when the not skiable zone at the bottom of the slope, of this disclosure. As show in the FIG. 8a, when the not skiable zone 6 is at village/day-lodge 1, by adding the new pick-up locations 11 and using drop-off locations 12, the middle skiable zone 7 keep to operate with most parts of the slopes.

FIG. 8b is a sketch diagram of the new pick-up and drop-off locations when the not skiable zone at the top of the slope, of this disclosure. As show in the FIG. 8b, when the not skiable zone 6 is at mountain top L, by adding the new drop-off location 12 and pick-up location 11, in the middle skiable zone 7 keep to operate with most parts of the slopes.

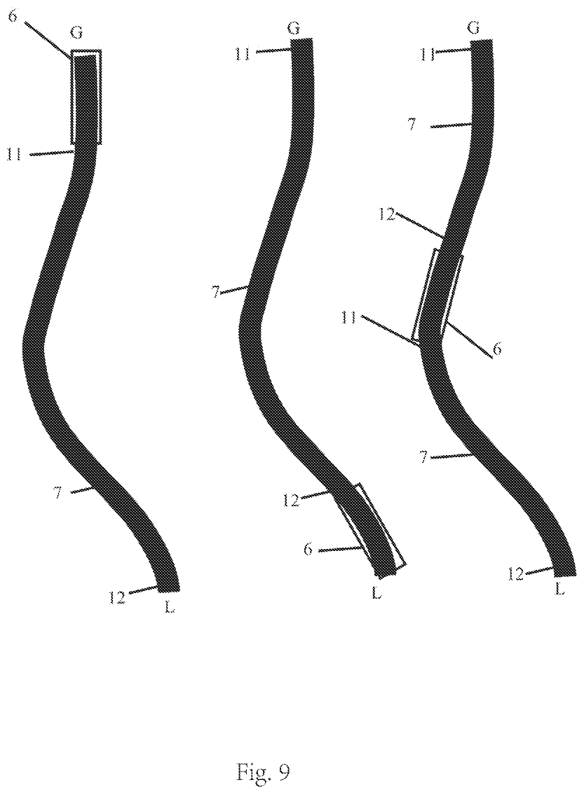

FIG. 9 is a sketch diagram of different cases of non-skiable zones in the ski slopes in this disclosure.

No matter where the non-skiable zone 6 is at ski slope bottom-village/day-lodge G, or at the top the mountain top L, or in the middle of the ski slope, the skiable zone 7 can be continued to operate with new pick-up location 11 and new drop-off location 12, partially open slope may be any combination of these three cases.

To replace the traditional lift, Ski Resort Mass Transit Transportation System in this disclosure has following advantages:

The ski resort mass transit transportation system hourly capacity and investment is permanently adjustable to the skier demand.

Ski Resort Mass Transit Transportation System can operate at night and is not subject to the limitation of aerial ropeway rules (night rescue are not authorized). It allows having a regular business at night in ski resort, for example, the altitude restaurant or altitude hotel with no road access can operate at night. The Ski Resort Mass Transit Transportation System is composed of plenty of individual vehicles going up or down.

The Dispatchable Vehicle System will allow snow to be carried to any location on ski slopes where snow is in shortage and there is no need to lay out any pipes network along the ski slope to make snow. The Dispatchable Vehicle System can be used to carry snow when there is no need of carrying skiers, typically before the ski season start or in nights of the ski season. Then the investment cost of snow making system can be reduced. In addition most of the snowmaking system is then movable which will allow financing by leasing or with mortgage.

The Dispatchable Vehicle System will make the Vehicles easy to resale as secondhand and relocate them in another ski resort, and this will allow the financing by lease or mortgage of the skier's transportation system in a man-made ski resort.

The Dispatchable Vehicle System can be delivered to ski resorts within 1 month and does not need installation, but time-saving. The Dispatchable Vehicle System need inspection only in manufacturer's factory, no need the time-consuming annual inspection on site.

The Dispatchable Vehicle System has its loading/unloading executed on stopped vehicles, it's safe for skiers. Most of the lifts are loading and unloading skiers on moving vehicle.

In this disclosure, break down of one individual vehicle in the Dispatchable Vehicle System has nearly no influence on ski resort operation.

In this disclosure, when wind is too strong in some areas of a ski resort, vehicles in this dispatchable vehicle system can continue moving or reroute its uphill way through a non-windy location.

In this disclosure, as the investment of the Dispatchable Vehicle System can be less than ¼ of an aerial lift for 5 km long, this allow to design profitable ski resort in mountain that cannot be profitable with aerial lift. The dispatchable vehicle system will change a ski slope network design, villages design and master plans of ski resort.

The Dispatchable Vehicle System will allow simultaneous service at multiple ski-starting locations and then renders some non-profitable ski slopes into profitable ones, and further changed the ski slope network in its master plan.

The Dispatchable Vehicle System can easily move some hourly transport capacity from one area to another during the same day which will lower investment and increase the IRR.

It should be stated in the end that: the above implement examples is only used to illustrate the technical scheme of this invention, not to limit it; although it describes this invention in detail with reference to the aforementioned examples, the common technicians in this field should understand: It may still modify the technical schemes as being described in the aforesaid examples, or replace some of the technical features equivalently; but those modifications and replacements will not make the essence of the corresponding technical scheme deviate from the spirit and scope of each example technical scheme of this invention.

1. A man-made ski resort operation and management system, comprising:
ski slope environmental data processing modules, to receive ski slope environmental parameters, judge if the environmental data of each ski slope in the man-made ski resort map are within the preset critical value, to define the zones of ski slope in which the ski slope environmental data are not within the preset critical values, and sending the defined ski slopes network digital map to ski slope dispatch control centers;
the ski slope dispatch control center is used to real-timely receive the defined man-made ski slopes network digital map, as well as the transportation needs, and create a stop-ski order for the non-skiable zones according to the defined map and real-timely send to each vehicle dispatch control center.

2. The man-made ski resort operation and management system according to claim 1, wherein the ski slopes environmental parameters comprising: the thickness, hardness and density of snow on slopes; the weather conditions of ski resort area; obstacles on ski slopes.

3. The man-made ski resort operation and management system according to claim 2, wherein the ski slope environmental data processing module communicate with the ski slope dispatch control center.

4. The man-made ski resort operation and management system according to claim 3, further comprising: the ski slopes network environmental parameters database which is used to receive and store the ski slope environmental parameters, and send the ski slope environmental parameters to the ski slope environmental data processing module;
the ski slope environmental parameter database communicate with the ski slope environmental data processing module;
the man-made ski resort digital maps are stored both in the ski slope environmental data processing module and the ski slope dispatch control center, this man-made ski resort digital map comprising all ski slopes, accommodations, car parks and restaurants locations in ski resort area.

5. The man-made ski resort operation and management system according to claim 1, wherein the ski slope environmental data processing module is also used: to receive the information of user's request and objects to be transported, the information of user's request and objects to be transported is to be resolved into user location and needs according to the user location and needs transmit the transportation order to the nearest and suitable vehicle.

6. The man-made ski resort operation and management system according to claim 1, further comprising: sending transportation needs to: the dispatchable vehicle system, and comprising many vehicles, the vehicles are used to receive the executive order sent by the ski slope dispatch control center, and the vehicles move according to the executive order;
the vehicles in the dispatchable vehicle system communicate with the ski slope dispatch control centers;
each vehicle in the dispatchable vehicle system comprising vehicle engine and vehicle cabin, and the vehicle cabin is determined according to objects to be transported;
each vehicle in the dispatchable vehicle system is Alvis Bv206S caterpillar armored full terrain vehicle;
in the dispatchable vehicle system, vehicles are equipped with snow making machine and water tanks, for the purpose to manufacture snow while moving in slow motion along ski slopes;
the vehicles in the dispatchable vehicle system are equipped with different type passenger cabins and different cabins are fixed with different prices.

7. The man-made ski resort operation and management system according to claim 4, wherein the ski slope environmental parameters received by the ski slope environmental parameter database are transmit through manual input, automatic sensors or external database.

8. The man-made ski resort operation and management system according to claim 1, wherein the ski slope dispatch control center is also used to receive continuously ski slope images to analyze and detect in real time the traffic on a ski slope, when the traffic on the slope is over the preset critical value, edit and send to the ski slope dispatch control center the signal of stopping or reduce or reroute to another slope, so as to guide ski slope users away from the over-loaded ski slope.

9. The man-made ski resort operation and management system according to claim 1, wherein the ski slope dispatch control center is also used to receive continuously ski slope images to analyze and detect in real time the dangers of the obstacles on a ski slope, when they are not within the preset critical values, edit and send to the ski slope dispatch control center the signal of stopping or reduce or reroute to another ski slope, so as to guide ski slope users away from the ski slope with obstacles.

10. The man-made ski resort operation and management system according to claim 1, wherein the ski slope dispatch control center is also used to receive continuously ski slope images to analyze and detect in real time accidents on a ski slope, when there is an accident on the slope, edit and send to the ski slope dispatch control center the signal of reroute to another ski slope, so as to guide skiers away from the slope with the accident.

11. The man-made ski resort operation and management system according to claim 1, wherein the ski slope dispatch control center is also used to receive continuously ski slope images to analyze and detect in real time the skier quantity and traffic on ski slopes, inform ski slope users through mobile terminals and have the information displayed on screens installed along ski slopes, in the ski resort and in vehicle.

12. The man-made ski resort operation and management system according to claim 1, further comprising: the ski slope dispatch control center is also to use AI (artificial intelligence) to predict the ski slope traffic flow according to the past experience and the today conditions.

13. A management method of realizing the man-made ski resort operation and management system, comprising following steps:
making use of the ski slope environmental data processing modules to receive ski slopes environmental data, judge if the environmental data of each ski slope in the man-made ski resort map are within the preset critical values, define the zones of ski slope in which the ski slope environmental parameters are not within the preset critical value, and send the defined ski slopes network digital map to ski slope dispatch control centers; the ski slope dispatch control center is used to real-timely receive the defined man-made ski slopes network map and create a stop-ski order for the non-skiable zones according to the defined digital map and real-timely send to each vehicle terminal.

14. The management method according to claim 13, wherein the ski slope environmental parameters comprising: snow thickness, hardness and density on slopes, the weather conditions in ski resort area, obstacles on ski slopes.

15. The management method according to claim 14, further comprising: taking use of the ski slope environmental parameter database to receive and store the ski slope environmental parameters, and send the ski slope environmental parameters to the ski slope environmental data processing modules;
the man-made ski resort digital maps are stored both in the ski slope environmental data processing module and the ski slope dispatch control center, this man-made ski resort digital map comprising all ski slopes of the ski resort areas, the accommodation, car parks, and restaurants, pickup points and delivery points locations in ski resort areas;
making use of ski slope environmental data processing module to receive information of user's request and objects to be transported, the information of user's request and objects to be transported is to be resolved into user location and needs according to the user location and needs transmit the transportation order to the nearest and suitable vehicle.

16. The management method according to claim 13, wherein the ski slope dispatch control center is also used to receive continuously ski slope images, to analyze and detect in real time the quantity and traffic on a ski slope, when the traffic on the slope is over the preset critical value, edit and send to the ski slope dispatch control center the signal of stopping or reduce or reroute to another slope, so as to divert ski slope users away from the over-loaded ski slope.

17. The management method according to claim 13, wherein the ski slope dispatch control center is also used to receive continuously ski slope images, to analyze and detect in real time obstacle and the dangerous level of these obstacles on a ski slope, when the dangerous level exceeds the preset critical value, edit and send to the ski slope dispatch control center the signal of stopping or reduce or reroute to another ski slope, so as to divert the ski slope users away from the ski slope with obstacles.

18. The management method according to claim 13, wherein the ski slope dispatch control center is also used to receive continuously ski slope images, to analyze and detect in real time accidents on a ski slope, when there is an accident on the slope, edit and send to the ski slope dispatch control center the signal of reroute, so as to divert skiers away from the ski slope with the accident.

19. The management method according to claim 13, wherein the ski slope dispatch control center is also used to receive continuously ski slope images, analyze and detect in real time the skier quantity and traffic on a ski slope, inform the ski slope users through mobile terminals of the traffic condition and have it displayed on screens installed along ski slopes and in the ski resort or in Vehicle.

20. The management method according to claim 13, further comprising: the ski slope dispatch control center is also to use AI (artificial intelligence) to predict the ski slope traffic using according to past experience and today conditions.

21. (canceled)

22. (canceled)

23. (canceled)

24. (canceled)

25. (canceled)

26. (canceled)

27. (canceled)

28. (canceled)

29. (canceled)

30. (canceled)

31. (canceled)
